(19) United States
(12) Patent Application Publication
(10) Pub. No.: US 2017/0264719 A1
(43) Pub. Date: Sep. 14, 2017

(54) Multi-Stream Interleaving for Network Technologies

(71) Applicant: QUALCOMM Incorporated, San Diego, CA (US)

(72) Inventors: Narasimha Rao Koramutla, San Diego, CA (US); Justin Edward Taseski, Shelby Township, MI (US)

(21) Appl. No.: 15/222,390

(22) Filed: Jul. 28, 2016

Related U.S. Application Data
(60) Provisional application No. 62/305,662, filed on Mar. 9, 2016.

(51) Int. Cl. H04L 29/08; H04L 29/06; H04L 12/24; H04L 12/26

(52) U.S. Cl. CPC H04L 69/324; H04L 43/106; H04L 67/148; H04L 69/22; H04L 41/50

(57) ABSTRACT

Methods for adding timestamps to packets from data streams in a computing network may include receiving, in a processor in the computing network, a plurality of data streams and building, by the processor a first packet from a first data stream in the plurality of data streams. The processor may further determine a value of a first timestamp for outputting the first packet that satisfies one or more parameters of the first data stream, add the first timestamp to the first packet, and hand over the first packet to a network device in the computing network.

### RELATED APPLICATIONS

This application claims the benefit of priority to U.S. Provisional Application No. 62/305,662 entitled “Multi-Stream Interleaving for Network Technologies” filed Mar. 9, 2016, the entire contents of which are hereby incorporated by reference.

### BACKGROUND

Newer automobile models are generally equipped with a number of end user electronic devices. These electronic devices may include, but are not limited to, compact disc (CD) players, digital versatile disc (DVD) players, MP3 players, radios, speakers, Global Positioning System (GPS) or navigation systems, modems, telematics modules, perimeter sensors and/or cameras, display screens, and cruise control systems. A network, such as an Ethernet network, may be used to connect the software or applications that control the end user devices and the end user devices themselves. An application may output a data stream, which is then packetized (i.e., converted into data packets) and transmitted through the network to the appropriate end user device.

There may be certain quality of service (QoS), latency, or other performance or priority requirements for the end user devices or applications. For example, a navigation system may have certain packet transfer rate requirements so that the system may display accurate positioning information. Ethernet Audio Video Bridging (AVB) is an emerging standard that may be used to establish QoS and interoperability standards for handling data streams in computing networks such as automotive network systems.

### SUMMARY

Various embodiments include methods implemented on a packetization device for adding timestamps to packets from data streams in a computing network. Various embodiments may include receiving a plurality of data streams, building a first packet from a first data stream in the plurality of data streams, determining a value of a first timestamp for outputting the first packet that satisfies one or more parameters of the first data stream, adding the first timestamp to the first packet, and handing over the first packet to a network device in the computing network.

Some embodiments may further include combining the first data stream with a second data stream in the plurality of data streams, building a combined packet from the combined data stream, in which the combined packet includes data from the first data stream and the second data stream, determining a value of a second timestamp for outputting the combined packet that satisfies one or more parameters of the first data stream and the second data stream, adding the second timestamp to the combined packet, and handing over the combined packet to the network device.

In some embodiments, the network device may be an Ethernet device. In some embodiments, each of the plurality of data streams may be generated by an application in a plurality of applications of the computing network. In some embodiments, the one or more parameters may include at least one of a quality of service requirement of the first data stream, a latency requirement of the first data stream, a minimum packet transfer rate for the first data stream, and a data type for the first data stream. In some embodiments, a shared data structure accessible by the processor may store data from the plurality of data streams and the one or more parameters of the first data stream.

Various embodiments include methods implemented on a network device for outputting packets in a computing network. Various embodiments may include receiving a first packet generated from a first data stream, in which the first packet includes a first timestamp that satisfies one or more parameters of the first data stream, reordering a plurality of received packets, including the first packet, according to a timestamp of each of the plurality of received packets, and outputting the first packet when the first timestamp expires.

In some embodiments, the network device may be an Ethernet device. In some embodiments, the one or more parameters may include at least one of a quality of service requirement of the first data stream, a latency requirement of the first data stream, a minimum packet transfer rate for the first data stream, and a data type for the first data stream. In some embodiments, the first packet may be received from a processor in the computing network and the method further include receiving a plurality of data streams including the first data stream, building the first packet from the first data stream, determining a value of the first timestamp for outputting the first packet that satisfies the one or more parameters of the first packet, adding the first timestamp to the first packet, and handing over the first packet to the network device.

Some embodiments may further include combining the first data stream with a second data stream in the plurality of data streams, building a combined packet from the combined data stream, in which the combined packet includes data from the first data stream and the second data stream, determining a value of a second timestamp for outputting the combined packet that satisfies one or more parameters of the first data stream and the second data stream, adding the second timestamp to the combined packet, and handing over the combined packet to the network device. In some embodiments, each of the plurality of data streams may be generated by an application in a plurality of applications of the computing network. In some embodiments, a shared data structure accessible by the processor stores data from the plurality of data streams and the one or more parameters of the first data stream.

Further embodiments include a packetization component including a processor configured with processor-executable instructions to perform operations of the methods summarized above. Further embodiments include a non-transitory processor-readable storage medium having stored thereon processor-executable software instructions configured to cause a processor of a packetization component to perform operations of the methods summarized above. Further embodiments include a packetization component that includes means for performing functions of the operations of the methods summarized above.

### BRIEF DESCRIPTION OF THE DRAWINGS

The accompanying drawings, which are incorporated herein and constitute part of this specification, illustrate example embodiments, and together with the general description and the detailed description given herein, serve to explain the features of the claims.

FIG. 1 is a functional block diagram of a computing network for use in accordance with various embodiments.

FIG. 2 is a functional block diagram of conventional data stream handling in a computing network.

FIG. 3 is a functional block diagram of software-based data stream interleaving in a computing network in accordance with various embodiments.

FIG. 4 is another functional block diagram of software-based data stream interleaving in a computing network in accordance with various embodiments.

FIG. 5 is a functional block diagram of a hardware-based data stream interleaving in a computing network in accordance with various embodiments.

FIG. 6 is a process flow diagram illustrating methods for interleaving streams in a computing network in accordance with various embodiments.

FIG. 7 is a process flow diagram illustrating methods for adding timestamps to packets from data streams in a computing network in accordance with various embodiments.

FIG. 8 is a process flow diagram illustrating methods for outputting data packets in a computing network in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

As used herein, the term “computing network” refers to any one or all of an automobile device network, residential device network, commercial device network, or other network that connects various electronic devices and applications together. As used herein, the terms “end user device,” “computing device,” and “electronic device” refers to any one or all of CD players, DVD players, MP3 players, radios, speakers, GPS or navigation systems, modems, telematics modules, perimeter sensors and/or cameras, display screens, cruise control systems, anti-lock brake systems, cellular telephones, smart phones, personal or mobile multi-media players, personal data assistants, desktop computers, laptop computers, tablet computers, servers, smart books, smart watches, palm-top computers, wireless electronic mail receivers, multimedia Internet-enabled cellular telephones, wireless gaming controllers, and similar personal or enterprise electronic devices that may be incorporated into a computing network.

Computing networks, such as those found in automobiles, may utilize a certain standard, such as Ethernet AVB, to maintain interoperability and QoS standards for applications and end user devices in the computing network. Certain profiles in the Ethernet AVB standard may expect that data stream packets should be sent periodically in accurate intervals to meet QoS requirements. For example, the class-A automotive profile expects 8000 packets/second, sent at exact intervals of 125 microseconds. Many central processing unit (CPU) cycles may be wasted to deliver such high packet rates. This results in the CPU being active all the time and may consume battery power and cause thermal issues, particularly in automotive environments.

Certain network controllers, such as an Ethernet controller, may include advanced hardware features such as timer-based packet launching features that allow the CPU to submit a bunch of packets with descriptors to the network hardware. The network hardware may check the time stamp in the descriptor and send the packet over the medium access control (MAC) layer. However, these features address the problem when transferring a single data stream and may not provide advantages in a system that supports multiple data streams.

In overview, various embodiments provide systems and methods for interleaving multiple data streams in a computing network. In a software-based approach, one or more packetization threads in the computing network may receive a plurality of data streams from a plurality of applications and compare one or more parameters of each of the plurality of data streams, such as QoS requirements and the number of data streams. The one or more packetization threads may select a first data stream in the plurality of data streams based on the comparison, build a packet from the first data stream, and transfer the packet to a network device driver.

In a hardware-based approach, one or more packetization threads in the computing network may receive a plurality of data streams from a plurality of applications, build packets from the plurality of data streams, and add a timestamp to each packet. For example, the packetization threads may create descriptors for each packet that includes the timestamp. The timestamp may represent a time delay for transmitting the data packet to the appropriate end user device. The one or more packetization threads may hand over the packet to a network device, which may scan all of the descriptors of received packets and outputs each of the packets when their respective timestamp expires. The hardware-based interleaving approach may simplify the software stack, because the packetizations threads do not have to perform the interleaving.

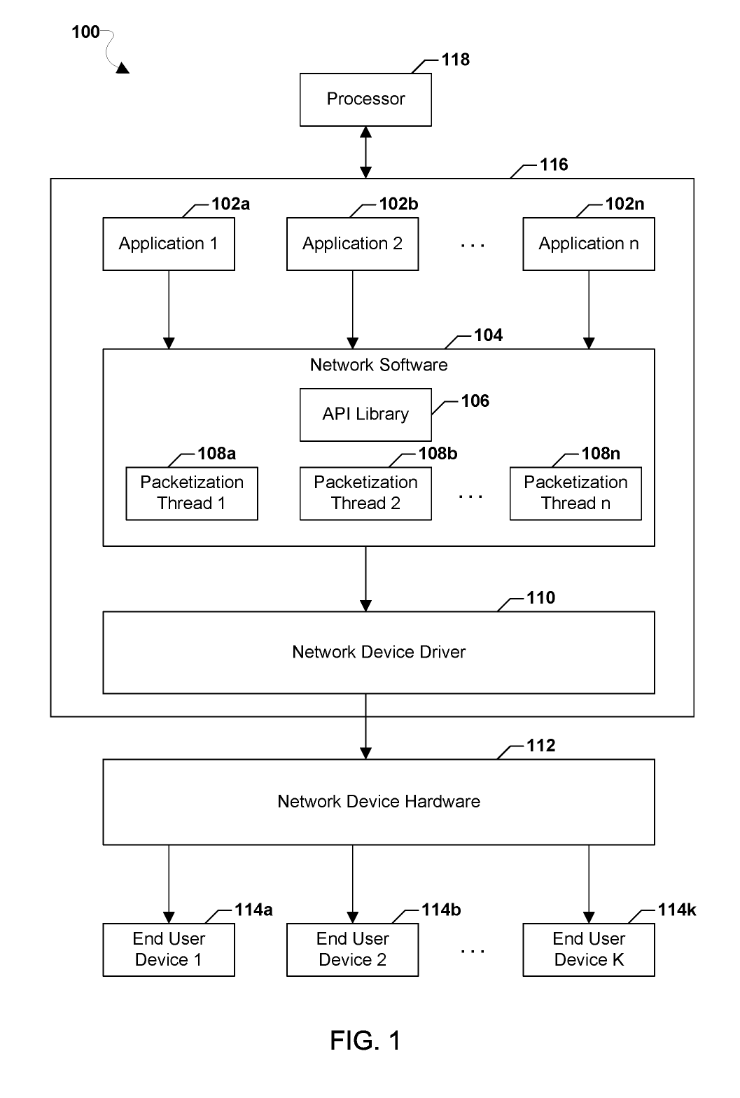

FIG. 1 is a functional block diagram of a computing network 100 suitable for implementing various embodiments. The computing network 100 may be part of, among other things, an automotive network system, or a residential or commercial network system. The computing network 100 may be implemented as an Ethernet network, or another network technology.

The computing network 100 may include one or more applications 102a-102n. The applications 102a-102n may be applications that control various end user devices 114a-114k in the computing network 100. For example, one application may be an audio application that controls one or more speakers. In another example, one application may be a GPS application that controls a navigation device. In some embodiments, there may be one application 102a-102n for every end user device 114a-114k. In alternative embodiments, some applications may control more than one end user device, or more than one application may control the same end user device.

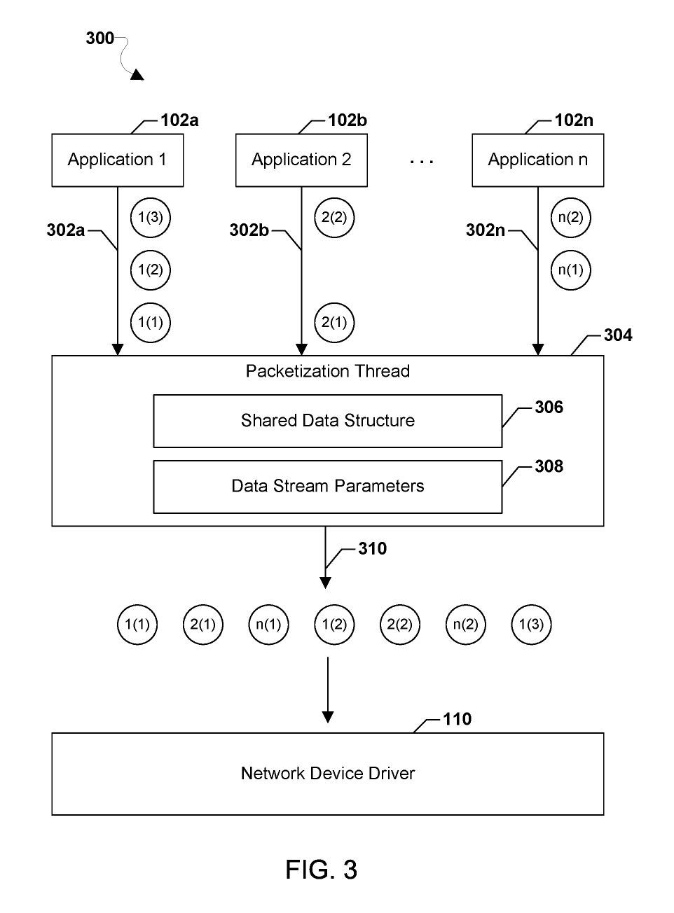

The applications 102a-102n may interact with network software 104 through an application programming interface (API) library 106. The network software 104 may be, for example, Ethernet AVB software. The network software 104 may format data generated from the applications 102a-102n into data packets using packetization threads 108a-108n. For example, the applications 102a-102n may invoke function calls in the API library 106 to initiate the packetizing process using a buffer pointer and the size of the data to be transmitted. In some embodiments, there may be one packetization thread 108a-108n for each application 102a-102n. The network software 104 may pass the data packets to a network device driver 110 that controls network device hardware 112. For example, the network device hardware 112 may be Ethernet network hardware and the network device driver 110 may be an Ethernet network driver. The network device driver 110 may hand over the data packets generated by the network software 104 to the end user devices 114a-114k through the network device hardware 112. The applications 102a-102n, the network software 104, and the network device driver 110 may be stored in memory 116. The memory 116 may be a non-transitory computer-readable storage medium that stores processor-executable instructions including the applications 102a-102n, the network software 104, and the network device driver 110. A processor 118 in the computing network 100 may be coupled to the memory 116 and execute instructions and applications stored in the memory 116. The computing network 100 may have additional components not shown in FIG. 1. Further, some components, such as the network device driver 110 and/or a packetization thread (see FIG. 3) may be implemented using dedicated hardware, such as dedicated buffers or registers, and/or a dedicated processor in addition or in place of another processor within the computing network. To encompass such embodiments, references may be made to implementing some operations in a processor and/or dedicated hardware.

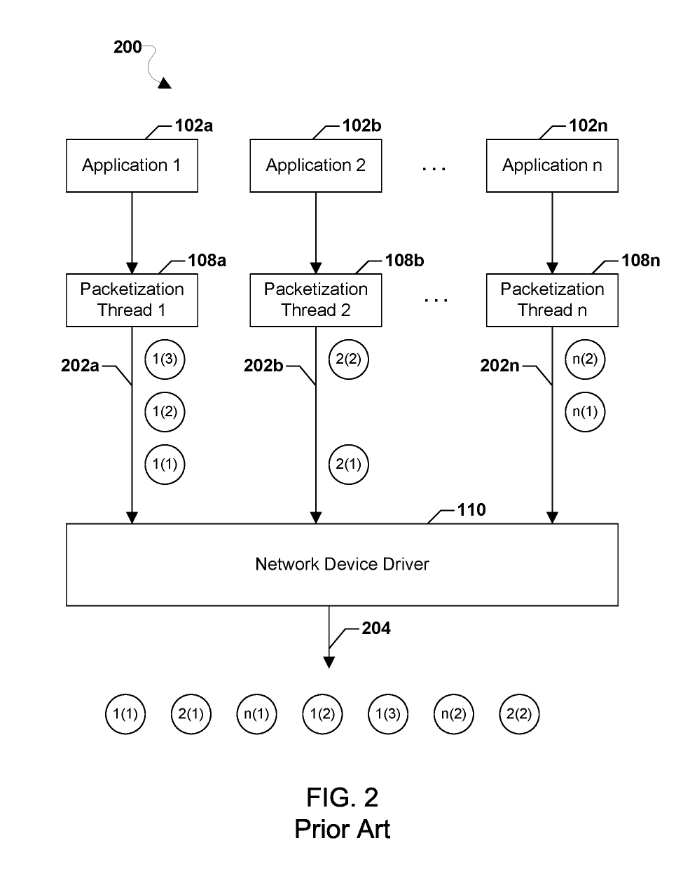

FIG. 2 illustrates a functional block diagram of conventional methods of data stream handling in a computing network 200. The computing network 200 may be implemented as an Ethernet network or another network technology, and may be part of an automotive network system, a residential network system, or a commercial network system, among other things. The computing network 200 may be a subset of the computing network 100 illustrated in FIG. 1.

The computing network 200 may include one or more applications 102a-102n that control various end user devices in the computing network 200. Each application 102a-102n generates a data stream that is sent to packetization threads 108a-108n. The data stream may be bursts of data of varying size as the data are generated by the applications 102a-102n. The packetization threads 108a-108n may periodically wake up to receive the data streams of each application 102a-102n and create data packets 202a-202n from the data streams. For example, the application 102a may have a packet data rate of 8,000 packets/second as is typical in automotive network systems. The packetization thread 108a may wake up every 125 microseconds to receive an input of a data stream from the application 102a to create the packets 202a. For illustration purposes, the data packets 202a may include a first packet 1(1), a second packet 1(2), and a third packet 1(3) shown in FIG. 2. In a similar fashion, the packetization thread 108b may receive an input of a data stream from the application 102b and create packets 202b, which may include a first packet 2(1) and a second packet 2(2). The packetization thread 108n may receive an input of a data stream from the application 102n and create packets 202n, which may include a first packet n(1) and a second packet n(2).

The data packets 202a-202n generated by the packetization threads 108a-108n may be handed over to the network device driver 110, which may generate an output 204 that is handed over to the network device hardware and on to end user devices connected to the computing network 200. The output 204 may be a sequence of data packets as the data packets are received from the packetization threads 108a-108n. The packetization threads 108a-108n may generate data packets 202a-202n independently from each other, and so the output 204 may be randomized as shown in FIG. 2. One or more of the applications 102a-102n may have certain QoS, latency, or other performance or priority requirements. For example, the application 102a may have a packet transfer rate of 8,000 packet/second while the application 102b may have a packet transfer rate of 4,000 packets/second. Thus, for every one data packet that belongs to the application 102b in the output 204, there should be two data packets that belong to the application 102a. However, the randomized nature of the output 204 may not satisfy the packet transfer rates of the applications 102a and 102b.

Various embodiments include methods for ordering data packets in a multi-stream computing network to improve serialization of the data packets within the network while satisfying the various QoS, latency, performance, or priority requirements of each data stream. FIG. 3 illustrates a software-based data stream interleaving in a computing network 300 in accordance with various embodiments. The computing network 300 may be implemented as an Ethernet network, or another network technology, and may be part of, among other things, an automotive network system, or a residential or commercial network system. The computing network 300 may be a subset of the computing network 100 illustrated in FIG. 1.

The computing network 300 may include one or more applications 102a-102n that control various end user devices in the computing network 300. Each application 102a-102n may generate a data stream 302a-302n that is sent to a packetization thread 304 executed by a packetization component in the computing network 300. Thus, a single packetization thread 304 may packetize the data streams from all the applications 102a-102n. The packetization thread 304 may have access to a shared data structure 306 that stores data received from the incoming data streams 302a-302n. The shared data structure 306 may be created from locally allocated memory by the packetization thread 304. The packetization thread 304 may also have access to data stream parameters 308. The data stream parameters 308 may include, but are not limited to, the total number of data streams, a quality of service requirement of each data stream, a latency requirement of each data stream, a most recent data stream for which a packet was handed over to the network device driver, a minimum packet transfer rate for each data stream, and a data type for each data stream (e.g., audio, video). The data stream parameters 308 may be stored in the shared data structure 306.

The packetization thread 304 may utilize the data stream parameters 308 to determine an order for generating data packets from the data stored in the shared data structure 306. For example, the packetization thread 304 may determine from the data stream parameters 308 that an output 310 should include a first data packet from each application 102a-102n, and then a second data packet from each application 102a-102n, and so forth as illustrated in FIG. 3. In another example, the packetization thread 304 may determine from the data stream parameters 308 that the application 102a has a packet transfer rate of 8,000 packet/second while the application 102b has a packet transfer rate of 4,000 packets/second, in which case for every one data packet that belongs to the application 102b in the output 310, there should be two data packets that belong to the application 102a.

The packetization thread 304 may also add a descriptor to each data packet. The descriptor may include various metadata about the data packet and may include a timestamp. The timestamp may indicate a delay for handing over the data packet to the end user device. For example, a data packet timestamp of 125 microseconds indicates that the network may hold the data packet for 125 microseconds before transmitting the packet to the end user device.

The packetization thread 304 may hand over the ordered packets in the output 310 to the network device driver 110, for example using a pointer to the generated data packet. The network device driver may hand over the packets to the computing network hardware, which may send the packets to the appropriate end user devices. In this manner, the packetization thread 304 performs multi-stream interleaving by receiving the data streams 302a-302n as inputs and producing an ordered output 310 by interleaving the packets of the data streams so that the various QoS, latency, performance, priority, and other requirements of each data stream 302a-302n are satisfied.

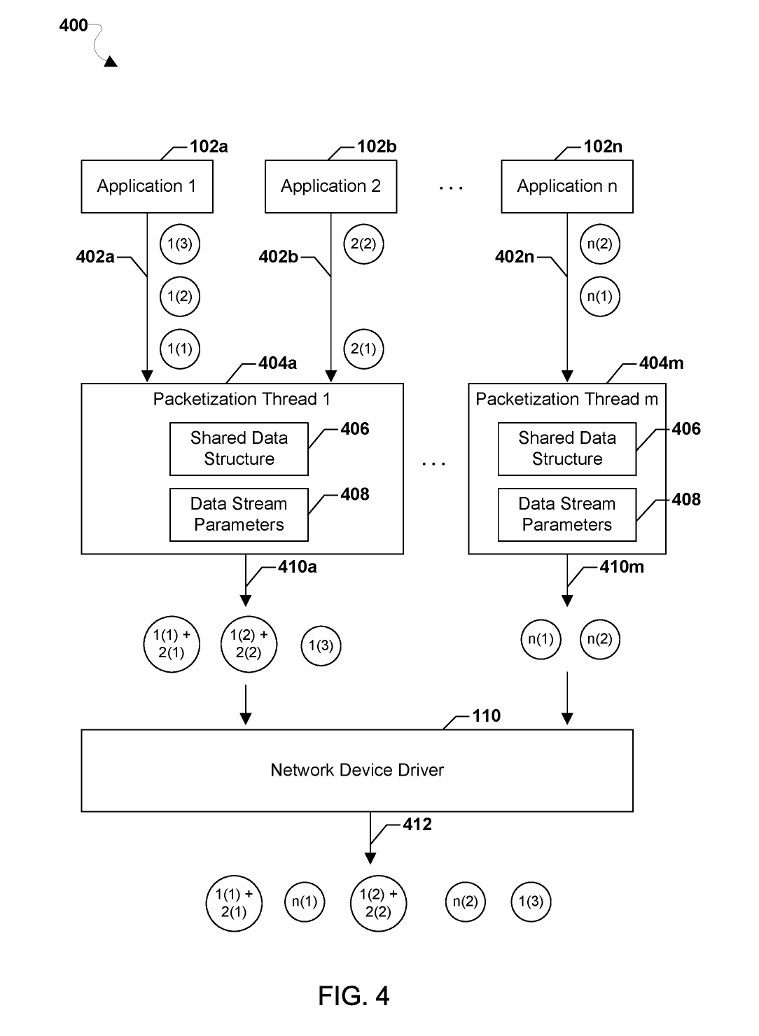

In some embodiments, there may be multiple packetization threads that work together to perform multi-stream interleaving. This is illustrated in FIG. 4, which illustrates another approach to software-based data stream interleaving in a computing network 400 in accordance with various embodiments. The computing network 400 may be implemented as an Ethernet network, or another network technology, and may be part of, among other things, an automotive network system, or a residential or commercial network system. The computing network 400 may be a subset of the computing network 100 illustrated in FIG. 1.

The computing network 400 may include one or more applications 102a-102n that control various end user devices in the computing network 400. Each application 102a-102n generates a data stream 402a-402n that is sent to one or more packetization threads 404a-404m executed by a packetization component in the computing network 400. Some packetization threads may perform packetizing for one application; for example the packetization thread 404m is illustrated packetizing the data from the data stream 402n. Other packetization threads may perform packetizing for more than one application, such as illustrated in packetization thread 404a that packetizes data from the data streams 402a and 402b. In some embodiments, the packetization thread 404a may combine data from multiple data streams into one packet. For example, the applications 102a and 102b may both control the same speaker, so the packetization thread 404a may combine the data from the data streams 402a and 402b. Each packetization thread 404a-404m has access to a shared data structure 406, in which each packetization thread 404a-404m may store data received from their respective data streams 402a-402n.

Each packetization thread 404a-404m may also have access to data stream parameters 408. The packetization threads 404a-404m may compare the parameters from each data stream to determine the data stream that should be packetized next. The packetization threads 404a-404m may packetize in a certain order based on the comparison of the data stream parameters 408.

For example, the packetization thread 404a may determine that data from the data streams 402a and 402b should be combine and packetized (e.g., packet 1(1)+2(1)), and then handed over to the network device driver in output 410a. The packetization thread 404m may then determine that the next packet to be generated should be from the data stream 402n (e.g., packet n(1)). The packetization thread 404a may then pause and the packetization thread 404m may generate packet n(1) from the data stream 402n in output 410m.

Thus, the packetization threads 404a-404m may preempt each other to generate packets in an order determined by comparing the data stream parameters 408. The outputs 410a-410m may be handed over to the network device driver 110. The network device driver 110 may combine the outputs 410a-410m from the packetization threads 404a-404m into a combined output 412 that preserves the ordering of the packets as generated by the packetization threads 404a-404m. The combined output 412 may then be handed over to the network device hardware and onto the appropriate end user devices.

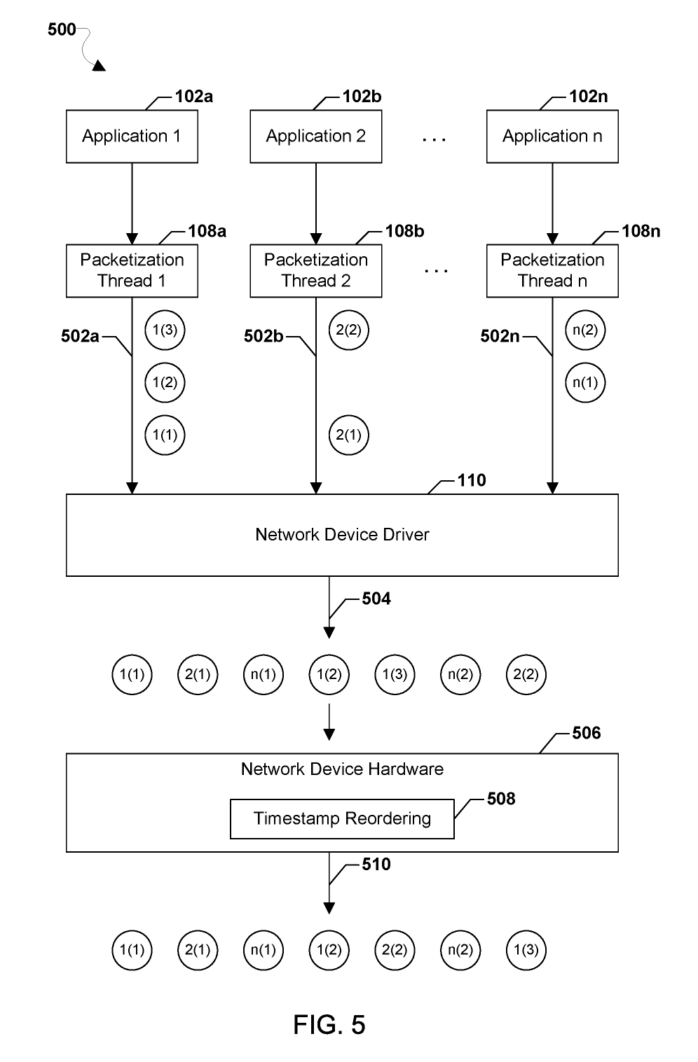

Alternatively, or in addition to software-based multi-stream interleaving as performed by the packetization threads 304 or 404a-404m, in some embodiments the network hardware may be configured to reorder the packets before packets are delivered to the end user devices. This alternative is illustrated in FIG. 5, which illustrates hardware-based data stream interleaving in a computing network 500 in accordance with various embodiments. The computing network 500 may be implemented as an Ethernet network, or another network technology, and may be part of, among other things, an automotive network system, or a residential or commercial network system. The computing network 500 may be a subset of the computing network 100 illustrated in FIG. 1.

The computing network 500 may include one or more applications 102a-102n that control various end user devices in the computing network 500. Each application 102a-102n generates a data stream that is sent to one or more packetization threads 108a-108n executed by a packetization component in the computing network 500. Each packetization thread 108a-108n may generate data packets 502a-502n independently of the other packetization threads. The packetization threads 108a-108n may add a descriptor to each data packet, which may include a timestamp that represents a time delay for transmitting the data packet to the appropriate end user device. The timestamp may be based on the QoS, latency, performance, or priority requirements of the data stream generated by the application 102a. For example, the data stream generated by the application 102a may have a data transfer rate of 8,000 packets/second. The packetization thread 108a may determine a time delay for each packet that is generated from the data stream of the application 102a that satisfies the data transfer rate of 8.000 packets/second. These time delays may be added to each packet as a timestamp. For example, the packetization thread 108a may add increments of 125 microseconds to the timestamp of each consecutive data packet that the packetization thread 108a creates from the data stream of the application 102a.

The data packets 502a-502n may be handed over to the network device driver 110, which may output 504 randomly ordered data packets.

The output 504 of the network device driver 110 may be received as an input by the network device hardware 506. The network device hardware 506 may include timestamp reordering circuitry 508. The timestamp reordering circuitry 508 may reorder the output 504 based on the timestamp of each data packet. The timestamp reordering circuitry 508 may have a buffer for storing data packets while their timestamps have not expired. For example, the packet 1(3) may be handed over to the network device hardware 506 before the packet 2(2). However, the packet 1(3) may have a timestamp of 500 microseconds while the packet 2(2) may have a timestamp of 250 microseconds. In that situation, the timestamp reordering circuitry 508 may hold both packets until their respective timestamps expire. For example, the packet 2(2) may be held for 250 microseconds and outputted, and the packet 1(3) may be held for 500 microseconds and outputted after the packet 2(2). The network device hardware 506 may transmit an output 510 that is a reordering of the data packets in the output 504 according to the timestamps of each data packet. Thus, the output 510 represents hardware-based multi-stream interleaving of data streams similar to the software-based multi-stream interleaving represented by the outputs 310 and 412. For example, the network device hardware 506, and in particular the timestamp reordering circuitry 508, may perform the interleaving that was performed by the packetization threads 304 and 404a-404m in FIGS. 3-4. The packetization threads 108a-108n in FIG. 5 do not have to perform interleaving and may packetize data streams in any order.

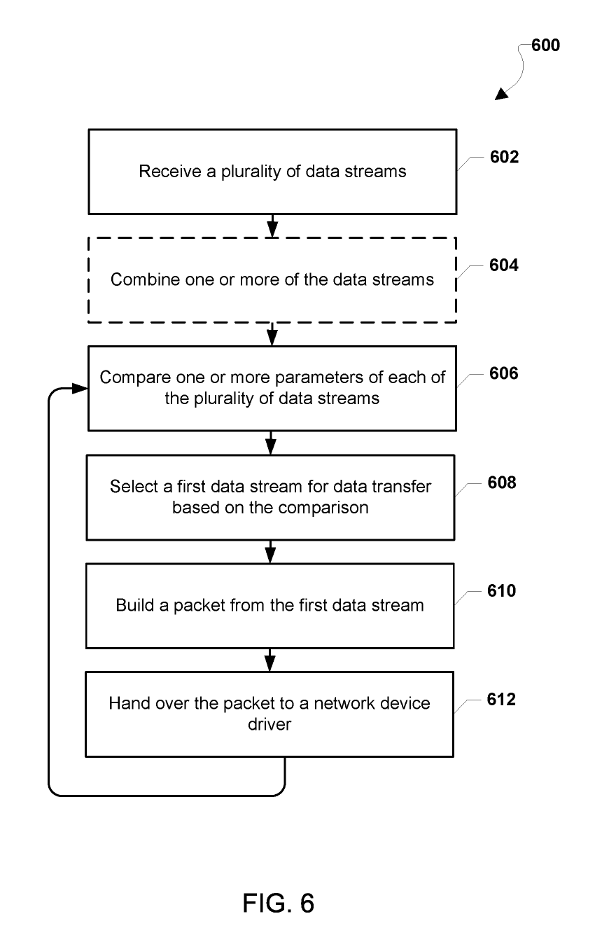

FIG. 6 illustrates a method 600 for software-based multi-stream interleaving in a computing network in accordance with various embodiments. The method 600 may be implemented by a processor and/or dedicated hardware of a packetization component in a computing network (e.g., the processor 118) that executes one or more packetization threads (e.g., the packetization threads 304, 404a-404m). The computing network may be implemented as an Ethernet network or another network technology, and may be part of an automotive network system, a residential network system, or a commercial network system, among other things.

In block 602, the processor and/or dedicated hardware may receive a plurality of data streams generated by a plurality of applications. The applications may control end user devices in the computing network. For example, in an automotive computing network, the applications may control devices such as CD players, DVD players, MP3 players, radios, speakers, GPS or navigation systems, perimeter sensors and/or cameras, display screens, cruise control systems, anti-lock brake systems. Each application may generate a data stream that is packetized and transmitted to the end user devices through the computing network. The data streams may be received by one or more packetization threads in the computing network software. The data in the data streams may be stored in a shared data structure accessible to all the packetization threads. The shared data structure may be, for example, an array.

In optional block 604, the processor and/or dedicated hardware may cause the one or more packetization threads to combine one or more of the data streams. For example, when two applications control a single end user device, the data streams from both applications may be combined into a single packet.

In block 606, the processor and/or dedicated hardware may cause the one or more packetization threads to compare one or more parameters of each of the plurality of data streams. The parameters may include, but are not limited to, the total number of data streams, a quality of service (QoS) requirement of each data stream, a latency requirement of each data stream, a most recent data stream for which a packet was handed over to the network device driver, a minimum packet transfer rate for each data stream, and a data type for each data stream (e.g., audio, video). The parameters may be stored in memory that is accessible to all the packetization threads, for example in the shared data structure.

In block 608, the processor and/or dedicated hardware may cause the one or more packetization threads to select a data stream in the plurality of data streams for packetization based on the comparison of the data stream parameters. For example, the one or more packetization threads may determine that the selected data stream packet has a higher QoS requirement than the other data streams and so the first data stream should receive priority in generating and handing over a data packet. In another example, the one or more packetization threads may determine that the selected data stream packet has a packet transfer rate of 8,000 packet/seconds, or a data packet every 125 microseconds, in which case every 125 microseconds the data stream should receive priority in generating and handing over a data packet.

In block 610, the processor and/or dedicated hardware may cause the one or more packetization threads to build a packet from the selected data stream. In some embodiments, the one or more packetization threads may also add a descriptor to the packet. The descriptor may include a timestamp that indicates a delay for handing over the packet to the appropriate end user device.

In block 612, the processor and/or dedicated hardware may cause the one or more packetization threads to hand over the packet to a network device driver. For example, a pointer to the data packet stored in memory may be sent to the network device driver. The network device driver may forward the packet to the network device hardware that delivers the packet to the end user device controlled by the application to which the data packet belongs. The processor and/or dedicated hardware may cause the one or more packetization threads to then compare one or more parameters of each of the plurality of data streams in block 606 to determine the data stream that should be packetized next (thus operating in a loop among blocks 606-612). In this manner, the method 600 provides a way for one or more packetization threads to interleave and packetize multiple data streams in a computing network to satisfy various parameters and/or requirements of each data stream.

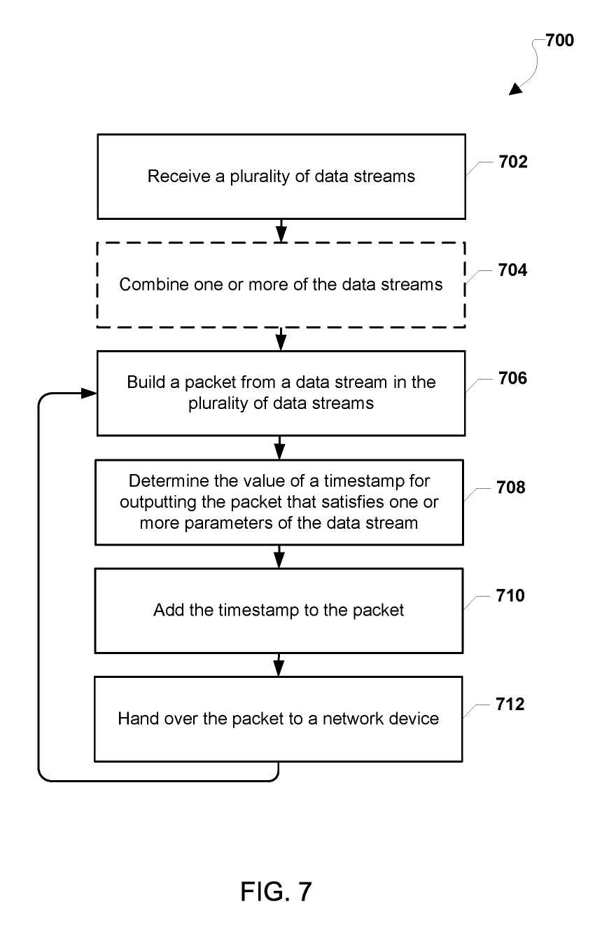

FIG. 7 illustrates a method 700 that may be implemented in software and/or hardware for performing multi-stream interleaving in a computing network in accordance with various embodiments. The method 700 may be implemented by a general purpose processor and/or a processor within dedicated hardware of a packetization component in a computing network (e.g., the processor 118) that executes one or more packetization threads (e.g., the packetization threads 304, 404a-404m). The computing network may be implemented as an Ethernet network, or another network technology, and may be part of, among other things, an automotive network system, or a residential or commercial network system.

In block 702, the processor and/or dedicated hardware may receive a plurality of data streams generated by a plurality of applications. The applications may control end user devices in the computing network. For example, in an automotive computing network, the applications may control devices such as CD players, DVD players, MP3 players, radios, speakers, GPS or navigation systems, perimeter sensors and/or cameras, display screens, cruise control systems, and anti-lock brake systems. Each application may generate a data stream that is packetized and transmitted to the end user devices through the computing network. The data streams may be received by one or more packetization threads in the computing network software. The data in the data streams may be stored in a shared data structure accessible to all the packetization threads. The shared data structure may be an array, for example.

In optional block 704, the processor and/or dedicated hardware may cause the one or more packetization threads to combine one or more of the data streams. For example, when two applications control a single end user device, the data streams from both applications may be combined into a single packet.

In block 706, the processor and/or dedicated hardware may cause the one or more packetization threads to build a packet from a data stream in the plurality of data streams. The data stream that is selected for packetization may be based on the arrival time of the data in the data stream. For example, the data stream that first transmits data to the one or more packetization threads may be selected for packetization.

In block 708, the processor and/or dedicated hardware may cause the one or more packetization threads to determine a value of a timestamp for outputting the packet that satisfies the one or more parameters of the data stream. The parameters of the data stream may include, but are not limited to QoS, latency, performance, or priority requirements of the data stream, as well as various attributes of the data stream, such as the data type and data size. For example, a data stream may have a minimum data transfer rate of 8,000 packets/second. The packetization thread may determine that a time delay of 125 microseconds for each consecutive data packet of the data stream may satisfy the minimum data transfer rate. In another example, packets from data streams with higher QoS or priority requirements may have shorter timestamps before they are output. In other examples, certain packet data types, such as navigation data, may have shorter timestamps than other packet data types, such as audio data. If the data stream has been combined with other data streams, the processor may determine the value of a timestamp that satisfies the parameters of all of the component data streams.

In block 710, the processor and/or dedicated hardware may cause the one or more packetization threads to add the timestamp to the packet. The timestamp may be included in a descriptor added to the packet, which may include various metadata for the packet.

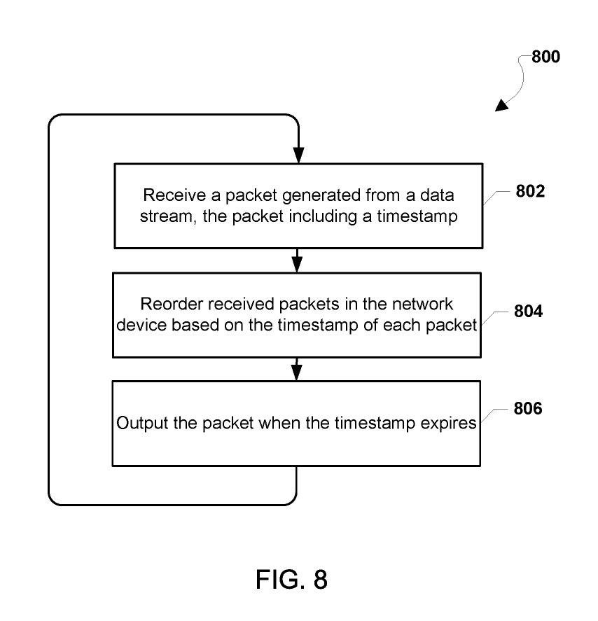

In block 712, the processor and/or dedicated hardware may cause the one or more packetization threads to hand over the packet to a network device, for example an Ethernet network device. The packet may be handed over from the one or more packetization threads through a network device driver to the network device. The network device may output the received packets, a method for which is described with reference to FIG. 8. In this manner, the method 700 provides a way to add timestamps to packets built from data streams in order to satisfy various parameters and/or requirements of each data stream.

FIG. 8 illustrates a method 800 that may be implemented in network hardware for outputting data packets in a computing network in accordance with various embodiments. The method 800 may be implemented by a network device (e.g., the network device hardware 506). The computing network may be implemented as an Ethernet network, or another network technology, and may be part of an automotive network system, a residential, or a commercial network system, for example.

In block 802, the network device may receive a packet from a packetization component in the computing network (e.g., the processor 118). The packet may be generated from a data stream in the computing network by one or more packetization threads in the computing network software executed by the packetization component, a method for which is described with reference to FIG. 7. A plurality of applications in the computing network may generate a plurality of data streams. The applications may control end user devices in the computing network. For example, in an automotive computing network, the applications may control devices such as CD players, DVD players, MP3 players, radios, speakers, GPS or navigation systems, perimeter sensors and/or cameras, display screens, cruise control systems, and anti-lock brake systems. Each application may generate a data stream that is packetized and transmitted to the end user devices through the computing network.

The data streams may be received by one or more packetization threads in the computing network software, which generates packets from the data streams. The packetization threads may add timestamps to each packet. The value of the timestamp may be determined to satisfy one or more parameters of the data stream from which the packet was generated. The parameters of the data stream may include, but are not limited to QoS, latency, performance, or priority requirements of the data stream, as well as various attributes of the data stream, such as the data type and data size. For example, a data stream may have a minimum data transfer rate of 8,000 packets/second. The packetization thread may determine that a time delays of 125 microseconds for each consecutive data packet of the data stream may satisfy the minimum data transfer rate. In another example, packets from data streams with higher QoS or priority requirements may have shorter timestamps before they are output. In other examples, certain packet data types, such as navigation data, may have shorter timestamps that other packet data types, such as audio data. If the data stream has been combined with other data streams, then the value of a timestamp may satisfy the parameters of all of the component data streams.

In block 804, the network device may reorder received packets based on the timestamp of each packet. The network device may include a buffer that stores packets received from the one or more packetization threads. As the packets are received and buffered, the network device may reorder the packets according to the timestamp of each packet. For example, the packets may be ordered by length of the timestamp, with the smallest timestamp ordered first because that packet will expire first and will be output when expired.

In block 806, the network device may output the packet when the timestamp expires. The network device may have circuitry that stores received data packets in a buffer, checks the timestamp of incoming data packets, and holds the data packets until the timestamps expire. For example, if the timestamp of the packet is 125 microseconds, the network device may hold the packet until 125 microseconds have elapsed, and then transmit the packet to the appropriate end user device. The network device may continue to receive, reorder, and output packets according to the timestamp of each packet by repeating the operations in blocks 802 to 806. In this manner, the method 800 provides a way for network hardware to output packets from data streams in a computing network to satisfy various parameters and/or requirements of each data stream.

The foregoing method descriptions and the process flow diagrams are provided merely as illustrative examples and are not intended to require or imply that the operations of various embodiments and implementations must be performed in the order presented. As will be appreciated by one of skill in the art the order of operations in the foregoing embodiments and implementations may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, units, circuits, and algorithm operations described in connection with the embodiments and implementations disclosed herein may be implemented as electronic hardware, computer software, or combinations of both. To clearly illustrate this interchangeability of hardware and software, various illustrative components, blocks, units, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, units, and circuits described in connection with the embodiments and implementations disclosed herein may be implemented in or performed by a variety of processors or combinations of processors, dedicated hardware and circuits. Examples of processors that may implement the various embodiments include general purpose processors, digital signal processors (DSP), application specific integrated circuits (ASIC), field programmable gate arrays (FPGA), and other programmable logic device, discrete gate or transistor logic, discrete hardware components, or any combination thereof designed to perform the functions described herein, alone or in combination with dedicated hardware and circuits. A general-purpose processor may be a microprocessor, but, in the alternative, the processor may be any conventional processor, controller, microcontroller, or state machine. A processor may also be implemented as a combination of computing networks, e.g., a combination of a DSP and a microprocessor, a plurality of microprocessors, one or more microprocessors in conjunction with a DSP core, or any other such configuration. Alternatively, some operations or methods may be performed by dedicated hardware in the form of components (e.g., buffers, data busses, and/or gate arrays) and circuitry that is specific to a given function.

In one or more example embodiments and implementations, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software unit that may reside on a non-transitory computer-readable or processor-readable storage medium. Non-transitory computer-readable or processor-readable storage media may be any storage media that may be used to store desired program code in the form of instructions or data structures and that may be accessed by a computer or a processor. By way of example but not limitation, such non-transitory computer-readable or processor-readable storage media may include random access memory (RAM), read only memory (ROM), electrically erasable programmable ROM (EEPROM), FLASH memory, CD-ROM or other optical disk storage, and magnetic disk storage or other magnetic storage devices. Disk and disc, as used herein, includes CD, laser disc, optical disc, DVD, floppy disk, and Blu-ray disc where disks usually reproduce data magnetically, while discs reproduce data optically with lasers. Combinations of the memory described herein are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of various embodiments and implementations is provided to enable any person skilled in the art to make or use the claims. Various modifications to these embodiments will be readily apparent to those skilled in the art, and the generic principles defined herein may be applied to some embodiments without departing from the scope of the claims. Thus, the present disclosure is not intended to be limited to the embodiments and implementations shown herein but is to be accorded the widest scope consistent with the following claims and the principles and novel features disclosed herein.

What is claimed is:

1. A method for adding timestamps to packets from data streams in a computing network, comprising:
receiving, in a processor of a packetization component in the computing network, a plurality of data streams;
building, by the processor, a first packet from a first data stream in the plurality of data streams;
determining, by the processor, a value of a first timestamp for outputting the first packet that satisfies one or more parameters of the first data stream;
adding, by the processor, the first timestamp to the first packet; and
handing over, by the processor, the first packet to a network device in the computing network.

2. The method of claim 1, further comprising:
combining, by the processor, the first data stream with a second data stream in the plurality of data streams;
building, by the processor, a combined packet from the combined data stream, wherein the combined packet comprises data from the first data stream and the second data stream;
determining, by the processor, a value of a second timestamp for outputting the combined packet that satisfies one or more parameters of the first data stream and the second data stream;
adding, by the processor, the second timestamp to the combined packet; and
handing over, by the processor, the combined packet to the network device.

3. The method of claim 1, wherein the network device is an Ethernet device.

4. The method of claim 1, wherein each of the plurality of data streams is generated by an application in a plurality of applications of the computing network.

5. The method of claim 1, wherein the one or more parameters include at least one of a quality of service requirement of the first data stream, a latency requirement of the first data stream, a minimum packet transfer rate for the first data stream, and a data type for the first data stream.

6. The method of claim 1, wherein a shared data structure accessible by the processor stores data from the plurality of data streams and the one or more parameters of the first data stream.

7. A method for outputting packets in a computing network, comprising:
receiving, in a network device of the computing network, a first packet generated from a first data stream, wherein the first packet includes a first timestamp that satisfies one or more parameters of the first data stream;
reordering, by the network device, a plurality of received packets, including the first packet, according to a timestamp of each of the plurality of received packets; and
outputting, by the network device, the first packet when the first timestamp expires.

8. The method of claim 7, wherein the network device is an Ethernet device.

9. The method of claim 7, wherein the one or more parameters include at least one of a quality of service requirement of the first data stream, a latency requirement of the first data stream, a minimum packet transfer rate for the first data stream, and a data type for the first data stream.

10. The method of claim 7, wherein the first packet is received from a packetization component in the computing network, the method further comprising:
receiving, by the network device, a plurality of data streams including the first data stream;
building, by the network device, the first packet from the first data stream;
determining, by the network device, a value of the first timestamp for outputting the first packet that satisfies the one or more parameters of the first packet;
adding, by the network device, the first timestamp to the first packet; and
handing over, by the network device, the first packet to the network device.

11. The method of claim 10, further comprising:
combining, by the network device, the first data stream with a second data stream in the plurality of data streams;
building, by the network device, a combined packet from the combined data stream, wherein the combined packet comprises data from the first data stream and the second data stream;
determining, by the network device, a value of a second timestamp for outputting the combined packet that satisfies one or more parameters of the first data stream and the second data stream;
adding, by the network device, the second timestamp to the combined packet; and
handing over, by the network device, the combined packet to the network device.

12. The method of claim 10, wherein each of the plurality of data streams is generated by an application in a plurality of applications of the computing network.

13. The method of claim 10, wherein a shared data structure accessible by the processor stores data from the plurality of data streams and the one or more parameters of the first data stream.

14. A packetization component in a computing network, comprising:
a processor configured with processor-executable instructions to perform operations comprising:
receiving a plurality of data streams;
building a first packet from a first data stream in the plurality of data streams;
determining a value of a first timestamp for outputting the first packet that satisfies one or more parameters of the first data stream;
adding the first timestamp to the first packet; and
handing over the first packet to a network device in the computing network.

15. The packetization component of claim 14, wherein the processor is further configured with processor-executable instructions to perform operations comprising:
combining the first data stream with a second data stream in the plurality of data streams;
building a combined packet from the combined data stream, wherein the combined packet comprises data from the first data stream and the second data stream;
determining a value of a second timestamp for outputting the combined packet that satisfies one or more parameters of the first data stream and the second data stream;
adding the second timestamp to the combined packet; and
handing over the combined packet to the network device.

16. The packetization component of claim 14, wherein the network device is an Ethernet device.

17. The packetization component of claim 14, wherein each of the plurality of data streams is generated by an application in a plurality of applications of the computing network.

18. The packetization component of claim 14, wherein the one or more parameters include at least one of a quality of service requirement of the first data stream, a latency requirement of the first data stream, a minimum packet transfer rate for the first data stream, and a data type for the first data stream.

19. The packetization component of claim 14, further comprising a memory configured with a shared data structure accessible by the processor storing data from the plurality of data streams and the one or more parameters of the first data stream.

20. A network device in a computing network, comprising:
a processor configured with processor-executable instructions to perform operations comprising:
receiving a first packet generated from a first data stream, wherein the first packet includes a first timestamp that satisfies one or more parameters of the first data stream;
reordering a plurality of received packets, including the first packet, according to a timestamp of each of the plurality of received packets; and
outputting the first packet when the first timestamp expires.

21. The network device of claim 20, wherein the network device is an Ethernet device.

22. The network device of claim 20, wherein the one or more parameters include at least one of a quality of service requirement of the first data stream, a latency requirement of the first data stream, a minimum packet transfer rate for the first data stream, and a data type for the first data stream.

23. The network device of claim 20, wherein the first packet is received from a packetization component in the computing network, and the processor is further configured with processor-executable instructions to perform operations comprising:
receiving a plurality of data streams including the first data stream;
building the first packet from the first data stream;
determining a value of the first timestamp for outputting the first packet that satisfies the one or more parameters of the first packet;
adding the first timestamp to the first packet; and
handing over the first packet to the network device.

24. The network device of claim 23, wherein the processor is further configured with processor-executable instructions to perform operations comprising:
combining the first data stream with a second data stream in the plurality of data streams;
building a combined packet from the combined data stream, wherein the combined packet comprises data from the first data stream and the second data stream;
determining a value of a second timestamp for outputting the combined packet that satisfies one or more parameters of the first data stream and the second data stream;
adding the second timestamp to the combined packet; and
handing over the combined packet to the network device.

25. The network device of claim 23, wherein each of the plurality of data streams is generated by an application in a plurality of applications of the computing network.

26. The network device of claim 23, further comprising a memory configured with a shared data structure accessible by the processor storing data from the plurality of data streams and the one or more parameters of the first data stream.

27. A non-transitory computer readable storage medium having stored thereon processor-executable software instructions configured to cause a processor of a packetization component to perform operations comprising:
receiving a plurality of data streams;
building a first packet from a first data stream in the plurality of data streams;
determining a value of a first timestamp for outputting the first packet that satisfies one or more parameters of the first data stream;
adding the first timestamp to the first packet; and
handing over the first packet to a network device in a computing network.

28. The non-transitory computer readable storage medium of claim 27, wherein the stored processor-executable software instructions are configured to cause the processor to perform operations further comprising:
combining the first data stream with a second data stream in the plurality of data streams;
building a combined packet from the combined data stream, wherein the combined packet comprises data from the first data stream and the second data stream;
determining a value of a second timestamp for outputting the combined packet that satisfies one or more parameters of the first data stream and the second data stream;
adding the second timestamp to the combined packet; and
handing over the combined packet to the network device.

29. The non-transitory computer readable storage medium of claim 27, wherein the network device is an Ethernet device.

30. The non-transitory computer readable storage medium of claim 27, wherein each of the plurality of data streams is generated by an application in a plurality of applications of the computing network.

31. The non-transitory computer readable storage medium of claim 27, wherein the one or more parameters include at least one of a quality of service requirement of the first data stream, a latency requirement of the first data stream, a minimum packet transfer rate for the first data stream, and a data type for the first data stream.

32. The non-transitory computer readable storage medium of claim 27, wherein a shared data structure accessible by the processor stores data from the plurality of data streams and the one or more parameters of the first data stream.

33. A non-transitory computer readable storage medium having stored thereon processor-executable software instructions configured to cause a processor of a network device to perform operations comprising:
receiving a first packet generated from a first data stream, wherein the first packet includes a first timestamp that satisfies one or more parameters of the first data stream;
reordering a plurality of received packets, including the first packet, according to a timestamp of each of the plurality of received packets; and
outputting the first packet when the first timestamp expires.

34. The non-transitory computer readable storage medium of claim 33, wherein the network device is an Ethernet device.

35. The non-transitory computer readable storage medium of claim 33, wherein the one or more parameters include at least one of a quality of service requirement of the first data stream, a latency requirement of the first data stream, a minimum packet transfer rate for the first data stream, and a data type for the first data stream.

36. The non-transitory computer readable storage medium of claim 33, wherein the stored processor-executable software instructions are configured to cause the processor to perform operations further comprising:
receive the first packet from a packetization component in a computing network;
receiving a plurality of data streams including the first data stream;
building the first packet from the first data stream;
determining a value of the first timestamp for outputting the first packet that satisfies the one or more parameters of the first packet;
adding the first timestamp to the first packet; and
handing over the first packet to the network device.

37. The non-transitory computer readable storage medium of claim 36, wherein the stored processor-executable software instructions are configured to cause the processor to perform operations further comprising:
combining the first data stream with a second data stream in the plurality of data streams;
building a combined packet from the combined data stream, wherein the combined packet comprises data from the first data stream and the second data stream;
determining a value of a second timestamp for outputting the combined packet that satisfies one or more parameters of the first data stream and the second data stream;
adding the second timestamp to the combined packet; and
handing over the combined packet to the network device.

38. The non-transitory computer readable storage medium of claim 36, wherein each of the plurality of data streams is generated by an application in a plurality of applications of the computing network.

39. The non-transitory computer readable storage medium of claim 36, wherein a shared data structure accessible by the processor stores data from the plurality of data streams and the one or more parameters of the first data stream.

40. A packetization component, comprising:
means for receiving a plurality of data streams;
means for building a first packet from a first data stream in the plurality of data streams;
means for determining a value of a first timestamp for outputting the first packet that satisfies one or more parameters of the first data stream;
means for adding the first timestamp to the first packet; and
means for handing over the first packet to a network device in a computing network.

41. The packetization component of claim 40, further comprising:
means for combining the first data stream with a second data stream in the plurality of data streams;
means for building a combined packet from the combined data stream, wherein the combined packet comprises data from the first data stream and the second data stream;
means for determining a value of a second timestamp for outputting the combined packet that satisfies one or more parameters of the first data stream and the second data stream;
means for adding the second timestamp to the combined packet; and
means for handing over the combined packet to the network device.

42. The packetization component of claim 40, wherein the network device is an Ethernet device.

43. The packetization component of claim 40, wherein each of the plurality of data streams is generated by an application in a plurality of applications of the computing network.

44. The packetization component of claim 40, wherein the one or more parameters include at least one of a quality of service requirement of the first data stream, a latency requirement of the first data stream, a minimum packet transfer rate for the first data stream, and a data type for the first data stream.

45. The packetization component of claim 40, further comprising means for storing data from the plurality of data streams and the one or more parameters of the first data stream in a shared data structure accessible by a processor.

46. A network device, comprising:
means for receiving a first packet generated from a first data stream, wherein the first packet includes a first timestamp that satisfies one or more parameters of the first data stream;
means for reordering a plurality of received packets, including the first packet, according to a timestamp of each of the plurality of received packets; and
means for outputting the first packet when the first timestamp expires.

47. The network device of claim 46, wherein the network device is an Ethernet device.

48. The network device of claim 46, wherein the one or more parameters include at least one of a quality of service requirement of the first data stream, a latency requirement of the first data stream, a minimum packet transfer rate for the first data stream, and a data type for the first data stream.

49. The network device of claim 46, wherein the first packet is received from a packetization component in a computing network, and the network device further comprises:
means for receiving a plurality of data streams including the first data stream;
means for building the first packet from the first data stream;
means for determining a value of the first timestamp for outputting the first packet that satisfies the one or more parameters of the first packet;
means for adding the first timestamp to the first packet; and
means for handing over the first packet to the network device.

50. The network device of claim 49, further comprising:
means for combining the first data stream with a second data stream in the plurality of data streams;
means for building a combined packet from the combined data stream, wherein the combined packet comprises data from the first data stream and the second data stream;
means for determining a value of a second timestamp for outputting the combined packet that satisfies one or more parameters of the first data stream and the second data stream;
means for adding the second timestamp to the combined packet; and
means for handing over the combined packet to the network device.

51. The network device of claim 49, wherein each of the plurality of data streams is generated by an application in a plurality of applications of the computing network.

52. The network device of claim 49, further comprising means for storing data from the plurality of data streams and the one or more parameters of the first data stream in a shared data structure accessible by a processor.
